(19) United States
(12) Patent Application Publication
(10) Pub. No.: US 2021/0055993 A1
(43) Pub. Date: Feb. 25, 2021

(54) Methods and Apparatuses for Robust Data Partition And Recovery

(71) Applicant: Anthony Mai, Menlo Park, CA (US)

(72) Inventor: Anthony Mai, Menlo Park, CA (US)

(73) Assignee: Anthony Mai, Menlo Park, CA (US)

(21) Appl. No.: 16/543,614

(22) Filed: Aug. 19, 2019

(51) Int. Cl. G06F 11/10

(52) U.S. Cl. CPC G06F 11/1076

(57) ABSTRACT

Methods and apparatuses for fast error detection and correction of computer data for resilient communication and storage; for encoding and recovery of data with some communicated or stored data parts lost; and for controlling access to data in a decentralized data storage system.

### CROSS-REFERENCE TO RELATED APPLICATIONS

None applicable.

### FIELD OF INVENTION

The current invention is applicable to application fields of information processing technology. Specifically, current invention is related to protection of data by transformation and partition so that if some parts of data is lost or damaged, the remaining data parts can be used to fully and reliably recover original data, given that available data parts meet certain requirements.

### BACKGROUND OF INVENTION

In the information technology industry, huge volumes of data are created, processed, transformed, transferred over networks, encoded, stored, retrieved, and recovered for usages. Each step of data processing involves physical materials and processes that can fail, resulting in data damage or loss. However most computing require correct data to work correctly. Advanced algorithms are applied to ensure data integrity amid potential physical corruption or loss of data.

For decades, researchers and engineers developed ways to reduce data loss from unreliable physical devices, using statistics and mathematics principles. For example, the same data can be stored at multiple locations. Even data at one location can be lost, it is unlikely that all data copies at all independent locations are lost at the same time. But simple data replication also multiplies the logistic costs, which is often undesirable or even unaffordable.

To achieve high data reliability without high cost of simple replications, Researchers have developed algorithms to generate redundant information to help to detect data errors and recover data from small damages. Such algorithms are called error correction codes (ECC). Algorithms that recover data from partial loss at known positions is also called erasure codes.

The most used error correction or erasure codes today is the Reed-Solomon Codes (RS). It was invented by Irving Reed and Gustave Solomon in 1960. Reed-Solomon Codes typically uses a notation of RS(N,K,S), like RS(9,6,8). It means a strip of data is split into K=6 blocks each has S=8 bits, And 3 parity blocks of 8 bits are calculated from 6 raw data blocks using a matrix of parameters. That results in 9 blocks, 6 are data blocks and 3 are parity blocks. The 9 blocks are stored separately. If up to 3 of them are lost, the remaining 6 blocks can still help to fully recover the original data. The ratio of number of recovered data blocks divided by number of surviving blocks required for recovery, is called coding efficiency. RS codes recovers K raw data blocks from any K surviving blocks, or 100% coding efficiency. Erasure codes with 100% coding efficiency are called Maximum Distance Separation (MDS) codes or optimal codes.

Although RS codes has a perfect coding efficiency, it has a high computation complexity, increasing in quadratic power of number of code blocks and code size. In practical applications, RS code can only handle small number of blocks and small blocks, like 8 bits.

Unsatisfied with the high computation costs of RS codes, researchers and engineers have developed several other error correction or erasure codes based on bit permutation and exclusive or bit operations. Such erasure codes include EvenOdd, RDP (Row Diagonal Parity), X codes, Liberation codes. All these code suffer from have very limited ways of permutations so they have very narrow usages, usually limited to up to 2 blocks lost. There is also Fountain codes and its variations Raptor codes, which provides unlimited number of permutations but they are not optimal, and only guarantee a certain possibility of successful decoding. So far there is no MDS codes with low complexity and low application limitations. Current invention changes that.

Reed-Solomon codes and other ECC algorithms define generator matrixes that multiply with input data, aggregate the results, and reduce the results to small code blocks. The volume of intermediate data is first expanded during the processing and then reduced, this inevitably leads to undesired computation complexity. Current invention changes that.

Global data storage demands are growing exponentially in recent years. By some estimates, annual growth of storage demand is reaching 45 zettabytes or 45 billion terabytes a year by 2020. Protecting this volume of data by simple replication is not cost effective. Internet companies are switching their data storage to use Reed-Solomon format in order to save storage space and save cost. But they find the computation complexity and cost of Reed-Solomon codes unacceptable. One data backup company reports that if one hard drive is lost, it takes 7 days to recover the lost data using Reed-Solomon codes. Another internet company reports that running Reed-Solomon codes to repair lost computer data consumes a big part of their datacenter computing resources even though only a small percentage of the data had been converted to Reed-Solomon encoding.

In the application fields of wired and wireless communications, the industry faces another obstacle. Emerging new communication technology like 5G wireless networks and IoT devices demand larger volume of data to be processed faster at lower latency. Communication channels need error correction code to work more reliably. The traditional Reed-Solomon codes can no longer meet the industry's demand on data encoding and recover speed.

Clearly, the world needs a new, much faster and more robust error correction codes and erasure codes to meet the growing data demands. Current invention meets these needs. The current invention, designed based on solid mathematics foundation, is a tangible innovation that can be reduced to many practical embodiments of apparatuses and systems, creating values.

### SUMMARY OF INVENTION

Present invention provides a series of methods and apparatuses for fast and robust error correction and erasure calculation, achieving perfect coding efficiency as Reed-Solomon Codes, but has a much smaller computation complexity. Present invention also provides methods and apparatuses for secured data storage on third party devices. Present invention has broad application value in many information technology fields related to protection of data from corruption and exposure, such as memory and processor chips, embedded systems, network communication devices and protocols, and mass scale cloud computing and storage.

Present invention takes a fundamentally different approach from the traditional Reed-Solomon codes and other error correction codes that apply a generator polynomial or a parameter matrix on input data to produce parity check code blocks. Present invention has no generator polynomials and no matrix operations. It just uses reducers to produce code blocks.

Present invention provides algorithms to produce any number of code blocks from K input data blocks, each block containing S data bits. The code blocks can be transmitted or stored, with possible losses. Present invention also provides the data recovery algorithms that guarantee full recovery of original data, given at least K of the data or code blocks remain. The algorithms can be notated as GC(N,K,S). For example, GC(20,16,128) means input data has K=16 blocks of S=128 bits, or 16 bytes in size. A total of N=20 code blocks of 128 bits are created and stored. Any 16 surviving code blocks can help recover the 16 original data blocks. So up to 4 blocks can be lost and data is still safe. Alternatively the algorithms allow all 16 data blocks to be retained, and create 4 code blocks, and store 20 blocks. Again, up to 4 blocks, either data or code blocks, can be lost, and all original data can still be recovered with any 16 surviving data or code blocks.

The algorithms provided by present invention have a small linear computing complexity, in comparison with the quadratic power complexity of Reed-Solomon codes. Thus present invention has a more broad application potential in a variety of information technology fields that require fast correction of data errors and data losses. Present invention is also superior than all other existing error correction/erasure codes known to the inventor's best knowledge.

The algorithms provided by the current invention uses arithmetic of binary Galois Fields, generally noted as GF(2^{m}). Mathematical techniques of small Galois Fields were used in some previous invented coding and cryptographic algorithms, including in Reed-Solomon codes and in the construction of AES algorithm. However, current invention provides some surprising new ways of using the Galois arithmetic. Such novel usage was not found in any prior art, to the best knowledge of current inventor.

Due to novelty and usefulness of current invention, it has great values in broad fields of application in all fields of information technology, including communication, data storage, cloud computing, artificial intelligence, embedded systems, IoT devices, consumer electronics.

Current invention contains 20 claims, with Claim 1 being the independent claim and the other 19 claims all depend on Claim 1 one way or another. This is because all claims involve finding and using reducers for modulo reductions based on the principles of the current invention.

### BRIEF DESCRIPTION OF DRAWINGS

FIG. 1 shows a hardware circuit based on claim 1, to process four blocks of input data, each block is 8 bits, and produce 4 code blocks for output, each block is also 8 bits, using 4 reducers 0x11B, 0x11D, 0x12B, 0x12D, which are irreducible themselves. The input data blocks are assumed in binary numeral representation. As shown in the diagram, the bit 8 is feedback and exclusive or-ed with some corresponding lower bits, depending on each reducer, for the modulo reduction as provided by step 1C.

Data blocks D0, D1, D2 and D3 are input from lower left side of the graph, highest bit of highest byte first, and lowest bit of lowest bytes last, one bit at a time. The input bits are feed in parallel into 4 bit shift registers and the bits are moved from the low bit position to the high big position. A bit that reaches bit 8 is feedback to exclusive or with some lower bits, depending on the reducer used in each bit shift register. There is also a bit counter which keeps track of bits. When a full data strip, or 32 bits, have been accumulated, the counter will send a trigger signal that causes the 4 bit shift registers to output their values at the top. Those outputs are the code blocks produced: C0, C1, C2 and C3.

### DETAILED DESCRIPTION OF INVENTION

The current invention provides methods and apparatuses to produce M code blocks, from an input of K original data blocks and M reducer parameters, and to recover all K blocks of original data from any N′ available blocks out of any of the M code blocks and K data blocks, given if and only if number of bits of N′ blocks add up to be no less than number of bits in the K data blocks. The current invention also provides methods and apparatuses to create said reducer parameters, with specific mathematics properties, and used in both encoding and decoding. As the steps of methods provided by current invention can be computed or processed very fast, the current invention is a superior replacement of the widely known and used Reed-Solomon codes.

The current invention allows all data blocks, code blocks and reducer blocks to have different block sizes. However in typical or preferred embodiments of current invention, all data and code blocks have the same number of S bits, and all reducer blocks having S+1 bits. Further, in typical embodiments, S is a bit width aligned with natural data types of the hardware system. For example on a generic x86_64 processor based system, embodiments using block bit length S of 16 bits, 32 bits, 64 bits or 128 bits is recommended. For convenient of discussion we assume S=128 bits unless otherwise stated. However the current invention covers embodiments of any variable bit length of each individual data, code, or reducer block, not just a fixed S of 2's power.

A reducer block of S+1 bits is used to reduce K data blocks of S bits each, for a total of K*S input bits, into a code block of S bits. According to current invention, a reducer must not be reducible by any other reducers. Said reducer blocks are selected using methods herein described in this document and in Claim 4, and such selection methods are covered and incorporated as parts of the claims of the current invention.

Embodiments may use alternative methods from Claim 4 to find reducers, or may call said reducers by other names. But all such variations of embodiments do not deviate from principles of current invention of using irreducible reducers and Galois arithmetic modulo reduction to create code blocks from data. Thus all such variations of embodiments are included and incorporated as parts of the claims of the current invention.

### Definitions of Terminology

Galois arithmetic. Current invention uses a special form of binary arithmetic on a finite field, first proposed by French mathematician Évariste Galois, with a notation GF(2^{s}). The basic rules of Galois arithmetic computation as used in current invention are explained as below:

a. Binary numbers are represented as a sequence of bits 1 and 0, in order of significance. The highest 1 bit, or the most significant bit is listed first, or on the left. The lowest bit, or least significant bit is listed last, or on the right. For example, decimal value 19 is represented as 10011, as 19=1*2⁴+0*2³+0*2²+1*2¹+1*2°. The leading bit represents 2⁴.

b. Binary numbers are added, subtracted, multiplied like binary arithmetic of natural numbers, but there is no carry over to a higher bit, nor borrowing from a higher bit. Instead the resultant bit value is simply wrapped around to within either 0 and 1. Therefore, additions and subtractions are the same. Both are exclusive or (XOR) bit operations. If two different bits are added or subtracted, it results in 1. If same bits are added or subtracted, the result is a 0 bit. Thus we have 1+1=1−1=0+0=0; 1+0=1−0=0−1=1.

c. Modulo Reduction: Binary values are modulo reduced by a reducer P with highest bit representing 2^{s}. According to current invention, modulo reduction is defined as repeatedly subtracting a left shifted value of P, so the two high bits are aligned, and subtraction cancels the highest bit of the result value, until the highest bit remaining is lower than highest bit s of P and so no more reduction is possible. Note this simple way of modulo reduction is just a definition of what the modulo reduction result should be. This definition method of modulo reduction may not be the most efficient as it only cancels one high bit at a time. Current invention provides other ways of calculating the modulo reduction. All variations in ways of calculating modulo reduction in practical embodiments do not deviate from basic principles of current invention and thus are included and incorporated as parts of claims of current invention.

d. Reducibility: Any binary number can be reduced by any reducer parameter, resulting in a residue number. However we specifically call it reducible or reduced to 0, when the reduction result is 0. If reduction is not 0, it is called irreducible or reduced to something.

d. Modulo Inverse of a number Y, or Y⁻¹, is defined so that the product of Y⁻¹* Y, reduced by P, equals 1. Division by X is defined as multiply by X⁻¹ and then reduced by P. As provided by current invention, modulo inverse can be calculated using Extended Euclidean reduction, or by calculating exponentiation Ŷ(2^{S}−1) according to Claim 3. Both approaches and other variations of calculating modulo inverse in practical embodiments do not deviated from the basic principles of using modulo inversion in the methods provided by current invention, and thus such variations are included and incorporated as parts of the claims of current invention.

e. Exponentiation X^{E} is a novel computation method provided by Claim 3 of the current invention. No prior art of such exponentiation exists. The exponentiation is defined as E count of X multiplied together and reduced by a reducer P. The reduction is done often, typically after each multiply or squaring, to keep the number of digits from growing too high and computation too complex. Claim 3 of current invention provides a method of calculating the exponentiation by reducing the calculation to ever smaller exponents. All variations in calculations of such exponentiation in all practical embodiments do not deviate from the basic principles of using said exponentiation in methods provided by current invention, and thus are included and incorporated as parts of the claims of the current invention.

Endianness and bit order. Computer data is stored or transferred in units of bytes. One byte contains 8 bits. Within a byte, bit 7 is the highest bit or most significant bit while bit 0 is the lowest or least significant bit. Bytes are stored sequentially in memory, going from a lower memory address to a higher memory address, with each address stores one byte. Depending on whether the most significant or the least significant byte is stored first at lower memory location, computer systems are classified as either big endian systems, where the most significant byte is store first, or little endian systems, where the least significant byte is stored first in memory.

Current invention handles both big endian and little endian systems. For the sake of discussion, we assume little endian systems unless otherwise indicated. Regardless of the endianness, human readable bit strings always go from left to right and from high to low bits. Thus, left, or shift left, means the higher, or bit shift to higher bit positions, and right is lower.

Data strip: Most data files are bigger than coding algorithms can handle in one pass. For convenience, data files are processed in parts called data strips. The residue of a data file which does not make a whole strip can be modified to make a strip, like padded with extra 0 bits and embedding length of padding for later recovery of exact file length. The methods provided by current invention process data strips which are further composed of K blocks of raw data. For example, in an embodiment, one block contains 128 bits or 16 bytes, and one data strip contains 8 blocks of data, or 128 bytes, and multiple code blocks can be created from each strip of data.

Raw data is the original data that data strips are extracted from. One purpose of methods of current invention is to encode data into multiple blocks and retain them separately, so even if some blocks are lost, the original data can still be recovered fully and exactly from remaining blocks. For this purpose, raw data is first processed to obtain data strips, then encoding is done on data strips to obtain code blocks to be retained separately. In recovery process, data strips are first recovered, and then they are used to reconstruct the original raw data.

Although it is simple and intuitive to just segment a data file into data strips. It is not the only way, nor is a data strip necessarily come from a single data file. Individual blocks or even data bits can come from different locations within a data file, or from different files from different sources and put together to form a data strip. The only requirement on data strips are that they should have pre-defined, easy to process sizes, and that when all data strips are recovered, they can be used to easily reconstruct the original raw data fully and exactly.

Claims 14 and 15 of current invention provides methods of constructing data strips from multiple data sources, instead of segmenting a data file into data strips, before encoding and recovery steps of current invention. All variations in practical embodiments in the ways of constructing data strips from raw data and reconstruction of raw data from data strips, do not deviate from the basic principles of the encoding and recovery methods as provided by current invention, and thus are include and incorporated as parts of the claims of current invention.

A data strip contains several data blocks. In binary representation, a data strip is treated as a binary number containing same number of bits as the data strip, with significance of the bits ordered in accordance to the system endianness. Likewise a data block or code block of 128 bits is treated as a binary number of also 128 bits. In such way, a data block has different valuation depending on location of the block within the data strip, with block 0 being the least significant and block K-1 being the most significant block, within a data strip of K data blocks.

Block numeral system. It is natural to consider a higher block in a data strip represent a block shifted S bits higher from a lower block. For example, a block with S=128 bits has 2¹²⁸ times the value of an identical block but at the next lower position. But it is not the only numeral representation of data blocks. Current invention provides a novel numeral system, called X-nary. Like integers are represented by various numeral systems such as binary, octal, decimal and hex, value of a data strip made of multiple data blocks has an X-representation, also called X-nary representation. In X-nary, a block is considered X times bigger when it is moved to a higher block position. X can be (2^{S}+x). The value of the data strip is T=D₀*X⁰+D₁*X¹+D₂*X²+ . . . +D_{K-1}*X^{K-1}. When X=(2^{S}+0) is used, the X-nary numeral representation reduces to the normal binary representation, i.e., each block is shifted S bits from a lower block positions. Using an X=(2^{S}+x) with a non-zero x may be desirable if modulo reduction is faster. X-representation (X-nary), and binary representation values can be converted to each other using same principles to convert between decimal and hex. Any multiplication and modulo reduction operations involving a data strip containing multiple blocks must consider the relative valuation of different blocks and thus must use either regular binary or X-nary numeral system. Different numeral value system of data strips in practical embodiments do not deviate from basic principles of current invention of using multiple reducers to produce multiple code blocks from the same input data, and are included and incorporated as parts of the claims of current invention.

Data block refers to block of data before encoding using methods of current invention, or after data recovery using methods of current invention. A data block typically contains a portion of unmodified raw data that needs protection. But it can also contain portions of original data with the bit order permutated or intermixed, but with no other modifications.

Code block refers to a block of data as produced by the encoding algorithms provided by current invention. Since code blocks are not put together to form data strips, a code block does not have a position within a data strip. A code block has an associated, related or corresponding reducer which is the reducer used to produce said code block.

Minimum data strip is the smallest possible data strip that when reduced by the given reducers will create given code blocks. A minimum data strip can sometimes be smaller than the original data strip used to produce code blocks. In such case, the minimum data strip alone is insufficient to recover the original data strip, and some surviving data block is needed.

Composite data strip is a data strip formed by multiplying all reducers with a non-zero value. As such a composite data strip is reducible, or reduced to zero by said reducers. Any composite data strip, when added to a recovery data strip, does not change modulo reductions, but modifies blocks in the recovery data strip. Thus it is used in conjunction with minimum data strips to produce a recovery data strip which matches with both code and data blocks. Claim 20 provides one method allowing composition of any desired composite data strips from a data set.

### Selection of Coding Parameters

As provided in Claim 1, Claim 2 and Claim 4, an X-nary numeral system and a set of M reducer parameters Pᵢ, with index i=0 to M-1, are found and selected for producing M code blocks, and for later recovery of the original data strip, allowing some data or code blocks become lost. It takes one reducer to compute each code block. Thus number of reducers used equals number of code blocks to be computed for each strip of raw data. The same reducers are normally reused to process the next data strips by the same methods. Code blocks created from the same reducer but from different data strips can be concatenated and stored on the same device, for convenient. Claim 1 and step 1C is the anchoring claim that reflects the basic principles of the current invention. All other claims depend on or use the methods in Claim 1.

Representation X and reducers should contain one bit more than number of bits of data or code blocks. For example, if block size is 128 bits, the coding parameters shall have 128+1=129 bits, with bit 128 is the highest bit, or represent 2¹²⁸, and bit 0 is the lowest bit.

As provided by Claim 4, reducer are selected by testing a candidate parameter with desired number of bits, and see if it qualify in meeting all the requirements. The process is repeated for many candidates until we find enough good reducers. This computation only needs to be done once, as suitable reducers are saved for future usages. The X of X-nary numeral value representation can be either just 2^{s}, i.e., regular binary representation, or X can be chosen in the same way as reducers, but X must be different from all reducers used.

There is one mandatory requirement and one preferential requirement on the reducer parameters. The mandatory requirement is that the reducer is only reducible by itself and by 1. Reducible means that the modulo reduction based on the Galois arithmetic rules as stated prior, is exactly 0. A binary value that is reducible only by itself and 1, is called an irreducible value. There are lots of irreducible values, but we only needs a few for encoding and decoding process. For example there are 2¹²⁸ possible 129 bits numbers. About 1 out of every 128 of them are irreducible and can be used as a reducer. Using irreducible reducers is one major principles of current invention and it is thus covered and incorporated as part of claims of current invention.

There is also a preference requirement that the reducer parameters should be sparse. That is, the parameters should have as fewer 1 bits as possible, and other than the highest 1 bit, all other 1 bits should be clustered near the low bit positions, away from the highest bit. An irreducible number which does not comply with the preferential requirement can still be used to produce correct encoding and decoding. But a good coding parameter should still comply with this preferential rule, to facilitate easier and faster computation.

An example 129 bits reducer is 2¹²⁸+2⁷+2²+2¹+2⁰, which is the lowest 129 bits reducer. All reducers must be odd, as even numbers are reducible by 2, thus not irreducible.

According to Claim 4, whether a candidate parameter is irreducible or not can be tested by exponentiation of a small number, called tester, for example 2 can be a tester. The tester E shall multiply by itself and then be reduced by the candidate reducer, in one round of operation. The result should multiply by itself again and be reduced by the candidate reducer again, for another round. The operation is repeated as many rounds as one less than the number of bits of the reducer parameter. That is, 128 rounds to test a 129 bits reducer parameter.

After each round of operation, the result, which is (E^{2̂i} mod P), is compared with initial tester value E. If a match is not found after the last round, the candidate reducer is reducible and is disqualified and discarded, and the next candidate should be picked and tested.

If a match with initial tester value is found after the last round, and only after the last round, then the tester is a strong one that proves the candidate parameter is irreducible, so it is accepted. If however a match is also found in a prior round, the tester is weak and inconclusive. The test should be repeated with a different tester. If we still cannot make a decision after exhausting a small pool of witnesses, the candidate parameter is given up and another candidate is tested. Typically, 10 or 20 testers is enough. Most reducers are decided on first tester, or 2.

Practical embodiments may use alternative means to test and discover suitable reducers and may call reducers by other names, and may discover such reducers by hardware instead of software, and may store or share collections of pre-calculated reducers for later use. All such variations of practical embodiments does not deviate from the basic principles as provided by current invention, of using multiple irreducible reducers to produce multiple code blocks by modulo reduction according to Galois arithmetic rules. Thus such embodiment variations are included and incorporated as a part of claims of the current invention.

### Design of Coding Settings

Before data encoding according to Claim 1 and Claim 2, decisions are made on how to split large files into data strips, how big are the blocks and how many blocks should a data strip contain, and how many code blocks should be generated from a data strip, and whether any or all of the original data blocks should be retained together with code blocks, etc.

For example, block size can be 128 bits. A data strip can contain 8 data blocks for a total of 128 bytes. For each strip, 4 code blocks are created using 4 different coding parameters. All 8 original data blocks and the 4 code blocks, total 12 blocks, can be stored in 12 places.

For another example, using the same block size and strip size, we can create 12 code blocks, and retain none of the 8 data blocks. The 12 code blocks are stored in 12 places.

In both examples, 12 blocks are stored separately. And it only requires 8 surviving blocks, whether data block or code block, to fully recover the original data strip of 128 bytes. The data durability, or the probability that no less than 8 blocks would survive to allow full data recovery, can be calculated using statistics based on probability of loss of any single block. Normally the binary distribution formula can be used for such calculation. Number of data blocks and code blocks per strip of data can then be designed based on desired data durability.

Calculation of expected data durability according to statistics is known science knowledge and thus is beyond the scope of discussion of this patent document. In general, the more blocks a data strip is transformed into, the less likely multiple block loss will occur, deviating from statistical means of expected failure rate, thus the less likely data is lost.

The design decisions of block size and number of blocks are made according to desired data durability, or the chance of any of stored blocks is lost during any period of time, and other cost and logistics considerations, based on principles of statistics and probability calculations. All such practical considerations in embodiments do not deviate from the basic principles of current invention, and are included and incorporated as parts of current invention.

### Data Strip Construction

Data files can vary in sizes so it is inconvenient to processing entire files in one pass. In methods provided by current invention, data are processed in data strips, or parts of data files.

There are many ways of extracting data strips from data sources for processing. The simplest way is just split a data file according to required data strip size. For example, if required data strip is 1024 bytes each, then a file can be split at every stretch of 1024 bytes.

But that is not the only way of to obtain data strips. An alternative is constructing data strips by taking interleaved bits, bytes or code blocks from the data source. By using such intermixing, the data durability might be improved.

Current invention provides a novel way of constructing data strips per Claim 14. Instead of obtain data strips from the same source and then place the data blocks and code blocks to many locations, resulting in future need of having to read data from multiple locations in order to access a data file, Claim 14 of current invention keeps data files at their locations. Instead, one data block from a different file from a different source is used to form a data strip to be used to create code blocks, and code blocks are stored separately. No data file is ever moved.

All such variations in practical embodiments of different ways to extract data strips from data sources, and to rebuild original data after data strips are recovered, do not deviate from the basic principles provided by current invention, of using multiple reducers to produce code blocks from data strips, and are included and incorporated as parts of claims of current invention.

### Multi-Level Coding Scheme

According to claim 16, after data strips are encoded resulting in a number of data and code blocks retained at different places to ensure data durability, each retained data or code blocks themselves can be considered as secondary raw data, and can be further processed and encoded and the resultant code block retained, to make original data or code blocks more resilient and less likely to be lost. If even more reliability is required, more encoding/decoding layers can be used to improve data durability to meet requirements. Typically a 2 or 3 levels encoding scheme is sufficient for reasonable data durability requirements. Such multi-level encoding schemes in practical embodiments do not deviate from the basic principles of current invention, and are thus included and incorporated as a part of the claims of current invention.

### Data Encoding Process

With block size and number of data blocks and number of code blocks decided, and a proper set of coding parameters selected per Claim 1 step 1A, the coding process can start.

Per Claim 1 step 1B: A strip of data is obtained from computer data. As described before, the data strip can come from simply splitting a data file, or from taking interleaved bits, bytes or blocks from a data source, or can be constructed from parts from different data sources. The strip of data has an X-nary numeral representation, with each higher data block position represents a value X times as high as the next lower block. In most typical embodiments, X is simply 2^{S}, or the data strip is in binary representation. The X-nary numeral system is taken into consideration when the data strip is modulo reduced by a reducer to produce a code block.

In Claim 1 step 1C, anchor of current invention, each reducer is used to produce a code block by modulo reducing the data strip by said reducer. Remainder from modulo reduction is the code block. A separate reducer is used to create each code block. There are many ways of calculating modulo reduction based the X-nary numeral system used. One such way provided by current invention is traversing from high to low blocks, folding each higher block to a lower one by multiplying it by (X mod Pᵢ) then reduced by reducer Pᵢ., the result is added to a lower block. This is repeated until there is only one lowest block left, which becomes the result code block. For another example, several blocks are canceled in each pass of calculation and folded to blocks of n positions lower, by first multiplying by (Xⁿ mod Pᵢ) then reduced by reducer Pᵢ. A specific X-nary numeral system can be used so the bits of (X mod Pᵢ) makes the computation efficient. All such embodiment variations of the X-nary numeral system and various ways of calculating modulo reduction do not deviate from the basic principles of the current invention, and are included and incorporated as parts of the claims of current invention.

Calculation of each code block is independent from each other and can be done in parallel. Alternatively, for faster computation, a few of the reducers can be multiplied into one combined reducer. The modulo reduction is first done using the combined reducer, then further reduced by each individual reducers to get the final code blocks to be retained.

For faster computation, modulo reduction is not carried out one bit at a time, but many bits at a time. Further, multi-bits Galois multiplication instructions can be used if they are available. For example, for 128 bits blocks, 2²⁵⁶ is modulo reduced by the coding parameter and this residue is used to multiply each of the data block, going from high to low, with the result added to the two lower data blocks. This is repeated until there are only 2 data blocks left, block 1 and block 0. Then Block 1 is multiplied by the residue of 2¹²⁸ modulo against the reducer, and the low part of multiplication result is added to block 0 while the high part replaces block 1. This is repeated until block 1 becomes 0. The final block 0 is the generated code block.

For even faster computation, the fore mentioned computation can be carried out not on single bits, but on a macro bit instead per Claim 10. One macro bit contains many parallel bits, like 64 bits. This leverages existing processor instruction sets, for each bit operation, we can operate on 64 bits in parallel at a time, boosting performance by roughly 64 times. Such parallelization does not deviate from the basic principles of encoding provided by the current invention, and is thus covered and incorporated as part of the claims of the current invention.

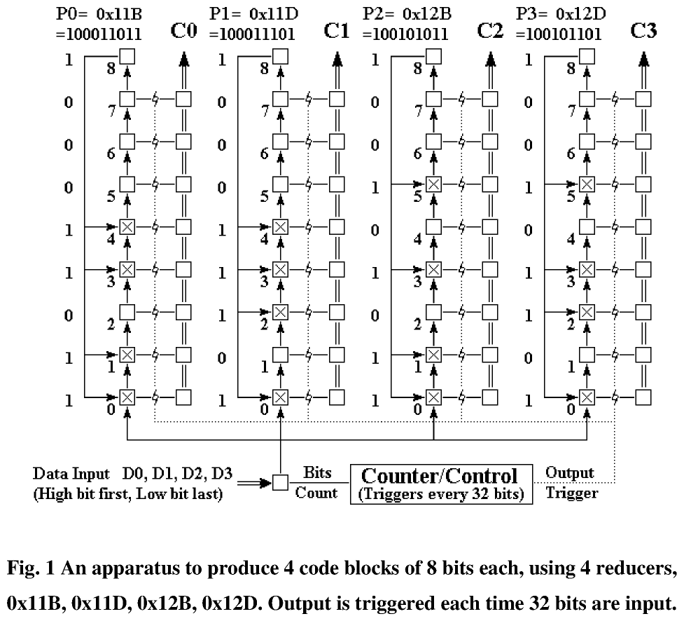

It is possible to implement the computation steps by hardware circuits. For example, the drawing FIG. 1 shows a simple circuit that takes an input of 32 bits of data to produce 4 code blocks, each 8 bits. More advanced circuit can be designed to handle much bigger block sizes than the example drawing, which necessarily has to be very simple in order to illustrate.

All such optimization in practical embodiments, in hardware and software form, including techniques not explicitly mentioned, do not deviate from basic principles of current invention, that multiple irreducible reducers are used to reduce data to produce separate code blocks, and thus are included and incorporated as a part of claims of the current invention.

### Data Error Detection and Correction

Data and code blocks produced by the encoding process as provided by current invention are retained separately, in the hope that not all of them are lost at the same time. When some of the blocks are lost, the remaining ones can still be used to fully recover the original data. Clearly, damaged data or code blocks are not used for recovery. Only good blocks are used.

But sometimes data may become partially corrupted without a clear sign it happened. How do we know if retained data or code blocks contain errors? The current invention provides methods to detect data errors, and to fix them if the errors are small, like just a few bits damaged.

Claim 5 provides a method to add a check block to a stretch of retained data or code blocks, using steps 5A to 5D. At a future time, data integrity is check by step 5E, by reducing the stretch of data using step 1C of Claim 1, and see if the result matches an expected marker. If a mismatch is found, there are errors in the data, and the data cannot be used unless it is fixed.

Claim 6 provides a method to fix a minor data error discovered using Method 5. An error block is calculated in step 6A, by subtracting expected marker from calculated reduction block. The error block is then shifted to different block positions. If X-nary numeral is used, the error block is shifted to a higher block position by multiplying by X⁻¹ then reduced by the reducer. An error location that produces an error block with the fewest set bits is determined to be the error location, and the error block is the error. It is added to the block location to fix the error. If no error location produces an error block with drastically fewer bits, the error is not recoverable and the entire stretch of data is discarded as lost.

### Data Recovery Process

Decoding is trying to fully recover the original data strips, from retained data or code blocks that are available. If original data strip contains K blocks, at least K data or code blocks are needed to recover data by computation. Claim 8, 9, 12, 13, 15, 20 pertain to methods of original data recovery according to the current invention, based on the data that is available. The basic principle of data recovery is to build a data strip which produces correct code blocks when reduced by related reducers, and which also agrees with all known data blocks. Claims 7 and 20 can be used as basic building blocks to construct the recovery steps to find such a data strip.

If original data blocks are retained with no loss, no data recovery is needed. If some code blocks are lost, the original data is used to recreate lost code blocks by going through the same coding step 1C of Claim 1 described before, but only for code blocks to be replaced.

If no data block is retained, a data strip of K data blocks can be recovered using steps of Claim 8. According to step 8A, an equal number K code blocks and their related reducers are used for data recover. According to step 8B, a minimum data strip Tᵢ is calculated for each code block Cᵢ. Then according to step 8C, all the minimum data strips are added together to recover the original data strip of K data blocks. A minimum data strip Tᵢ is reducible by reducer Pᵢ to the corresponding code block Cᵢ but reduced to 0 by all other reducers, and it is the smallest data strip with such properties. Claim 7 gives steps of one method to obtain such a minimum strip. Practical embodiments that vary on the computation steps to obtain said minimum strip do not deviate from the basic principles of Claim 8 of combining minimum data strips to recover a data strip, and thus are included and incorporated as a part of the claims of current invention.

If data blocks are retained and some data blocks are lost, all remaining data blocks and a number of code blocks equal to lost data blocks are used for data recovery, according to Claim 9. For example if 3 data blocks are lost, then 3 code blocks are used with all remaining data blocks for decoding. If available code blocks are more than needed, any 3 can be used.

The decoding principle of Claim 9 is to make a data strip T_{c} from several minimum data strips. T_{c} can be reduced to expected code blocks attributable to missing data blocks only. Then a composite strip, which is reducible by all reducers, is calculated to compensate for T_{c}'s modification of available data blocks so they are left intact. Finally, minimum data strips, the composite data strip, and known data blocks are combined to recover the full data strip. Claim 20 provides one method to construct said set of composite data strips used in step 9E of Claim 9.

With code blocks chosen for recovery, related reducers are identified for use. Based on the reducers set, a set of minimum data strips is created per step 9C of Claim 9. One method of creating a said minimum data strip is provided by steps of Claim 7. The minimum data strips, added together, can be reduced to each code block by each reducer. According to steps of Claim 7, for each reducer we first calculate the modulo inverse of the product of every other reducers, reduced by said reducer. This inverse is then multiplied by related code block and then reduced by the reducer, and multiplied by the product of all other reducers. Such minimum strips for each code block are added together to create a minimum data strip that is reduced by each reducer to the related code block. The result is T_{c} according to step 9D of Claim 9.

At this point, if only code blocks are used to recover the data strip, the decoding is done. The minimum data strip T_{c} obtained, is the original data strip. If some data blocks are used in the decoding, a few more steps are needed for decoding, as described in the following:

If there is only one data block missing or missing data blocks occupy contiguous positions, per step 9A, missing blocks are replaced with zero bytes. This data strip is used to produce code blocks per Claim 1 step 1C, and produced code blocks are subtracted from the code blocks used for recovery, the resulting code blocks are based on only missing data blocks. They are used to produce a minimum data strip T_{c} according to step 9C and 9D. T_{c} is shifted to cover the missing data blocks, by multiplying with the inverse of Xⁿ, with n being offset of first missing block, and reduced by the product of all the reducers. The final result are the missing data blocks. Combined with known data blocks, the entire data strip is recovered.

Alternatively, and in all other cases, an alternative recovery process is used. First all coding parameters in the recovery set are multiplied to produce M, which is reducible by any of these parameters. So adding a multiple of M to T_{c} does not change any code block. We want to find the right multiple X of M, so that X*M+T_{c} produces a data strip that agrees with all known data blocks. And that will be the decoded data strip.

To produce the recovered data strip, we start with data strip T_{c}, which can produce the correct code blocks, and we add several composites of M to change the bits of the data strip to match known data blocks. Claim 20 provides methods to find a set of composites Xᵢ*M, each contains one set bit within positions of the known data blocks. To find the set, we start with composite 2ⁱ*M, with i=0 to n-1, n being number of total bits of all known data blocks. For each bit position in recovery data blocks, we find an anchor composite with a set bit at the bit position. All other composites of M should have the anchor bit cleared by subtracting the anchor as necessary. Repeat the steps for all data bit positions to find all anchor composites.

Finally we traverse the candidate data strip to match it to each bit within the known data blocks. If a bit is wrong, a proper composite data strip, prepared by methods in Claim 20, is added to fix the bit. When all expected data bits match, a full data strip is recovered correctly: It can produce the expected code blocks while it also matches all the known data blocks exactly.

### Advanced Encoding and Recovery

The basic data encoding and recovery methods described so far, according to the current invention, can be extended for more advanced applications, for faster processing or advanced data protection features. Those extended methods are covered in claims 10 to 19. Specifically, as code blocks do not resemble original data blocks, and no recovery is possible unless enough number of code blocks are obtained, this feature is used in Claim 17,18,19 to control access to data based on providing some of code blocks and withholding some others.

Claims 10 and 11 provided the same encoding methods as Claims 1 and 2, but instead of data blocks containing individual bit, they are treated as containing groups of bits. Each group of bits is considered as a macro bit. For each bit operation as provided by the encoding methods, the bits in a group are operated on in parallel, leveraging computer processor instructions that operate on groups of bits in parallel in the same manner at the same time. for example an XOR instruction may do exclusive or bit operation on 64 bits of one register, against corresponding 64 bits of another register, produce a 64 bits third register value. This way, computations are much faster as many bits are operated on at the same time Likewise, Claims 12 and 13 provides bit parallel data recovery methods to operate on groups of bits in parallel, for faster computation.

### Embodiment Example One

In embodiment example one, pertaining to Claim 2, we use 128 bits block size. Each data strip contains K=4 blocks, and we produce 4 code blocks and retain 4 data blocks, for a total of 8 blocks. Binary numeral is used for blocks. We can recover data with up to 4 blocks lost.

The reducers are 129 bits, or (2¹²⁸+Cᵢ). Cᵢ=0x80141, 0x80205, 0x82801, 0x8A001. The 4 block or 64 bytes data strip is this text string in ASCII code, in big-endian byte order:

0123456789+ABCDEFGHIJKLMNOPQRSTUVWXYZ+abcdefghijklmnopqrstuvwxyz

In hex representation, the 4 data blocks each of 16 bytes, from high to low, are:

Block 3=303132333435363738392b4142434445

Block 2=464748494a4b4c4d 4e4f505152535455

Block 1=565758595a2b6162636465666768696a

Block 0=6b6c6d6e6f707172737475767778797a

The code blocks produced are:

Code 3=a598b47cb8a846215c672d8a470eb67e

Code 2=240b93d0503c4c9d f6f0fe0d04ab8766

Code 1=93ba87aea547cc4d 4ab1f57bb333bd5e

Code 0=7a86c6cb6e627f1a c2253f22daa6a149

Here is how Code 0 is produced from reducer C₀=2¹²⁸+0x80141. First, 2²⁵⁶ reduced by the reducer is R=0x4000011001. We use it to reduce the blocks in data strip, one block at a time, until there are 2 blocks left, using Galois arithmetic rules.

Block 3 multiplied by R=0 . . . 0c0c4cbfff 1c6cb88b5f2baddd 111d6c6632421445. The result is added to Block 2 and Block 1, producing:

Block 2=464748494a4b4c4d 4e4f505d5e1febaa

Block 1=4a3be0d20500ccbf 72790900552a7d2f

Block 2 multiplied by R=0 . . . 01191d25071 e85985f52116c1b16ced31234b0f4baa. The result is added to Block 1 and Block 0, producing:

Block 1=4a3be0d20500ccbf 72790911c4f82d5e

Block 0=8335e89b4e66b0c31f9944553c7732d0

With only two blocks left, Block 1 is reduced by 2¹²⁸ reduced by coding parameter, which is R₀=0x80141. Block 1 times R0 is 0 . . . 025187 f9b32e502004cfd9ddbc7b65682e24de. Adding the result to Block 1 and 0 results to 0 . . . 025187 7a86c6cb6e627f1a c2253f305459160e. Since Block 1 is not zero yet, the step is repeated: 0 . . . 0 0000000000000000000000128effb747. Adding it to Block 0 produces the final Code block 0 as: 7a86c6cb6e627f1a c2253f22daa6a149.

Implementation of the encoding steps may vary and may be done using either hardware or software functionalities that accelerate Galois arithmetic. Such embodiment variations do not deviate from principles of deriving code blocks using Galois arithmetic modulo reduction, and are thus included and incorporated as a part of the claims of the current invention.

### Embodiment Example Two

Refer to embodiment example one for reducers and produced code blocks. We recover the original data strip, using method of claim 9, with data block 0 lost, marked with strike-through:

Data 3=303132333435363738392b4142434445

Data 2=464748494a4b4c4d 4e4f505152535455

Data 1=565758595a2b6162636465666768696a

Data 0=

[symbol]

Code 3=a598b47cb8a846215c672d8a470eb67e

Code 0=7a86c6cb6e627f1a c2253f22daa6a149

We lost one data block, block 0. Any one code block can be used to recover the data. We use Code 0=7a86c6cb6e627f1a c2253f22daa6a149. Original reducer is 2¹²⁸+0x80141.

We replace lost code block 0 with 0 bytes, per step 9A, and reduce the data strip in step 9B by the same reducer to produce this code block: 11eaaba501120e68b1514a54added833. Add it to the original code block produces this: 6b6c6d6e6f707172737475767778797a. Since missing data block is block 0, with 0 offset, the result is correctly recovered data block 0.

### Embodiment Example Three

Refer to embodiment example one and two for the same encoding parameters and the same data strip to be recovered. In this case, all data blocks are lost, we use 4 code blocks to recover the data strip, using coding parameters (2¹²⁸ +) 0x80141, 0x80205, 0x82801, 0x8a001.

According to methods of claim 7 and step 7A, for reducer P₀, we multiply all other reducers to produce: M₀=P₁*P₂*P₃.

M₀=[. . . 01] [. . . 088a05] [. . . 04010122001] [. . . 022201f3541aaa05]. Likewise for P₁,P₂,P₃ we get:

M₁=[. . . 01] [. . . 088941] [. . . 04011aa0001] [. . . 0222dd0551a28941]

M₂=[. . . 01] [. . . 08a345] [. . . 04001c80501] [. . . 0228df013be0a645]

M₃=[. . . 01] [. . . 082b45] [. . . 04000702501] [. . . 020ad2c16cf00e45]

The modulo inverse of (M₀ mod P₀) is R₀=e8b88305a51728b135f1174132e7bfb3. Multiply it by Code Block 0 and modulo reduced by P₀: 082bef6fb44c81482ee62772007aaa88. Then multiply by M₀ produces data strip S₀:
S₀=082bef6fb44c81482ee62772007aef93 aceb8859d29335004022cd532aeca65f b586afa8091089cded702a716d0ec7da 8200c5e9d4d1edc7902508b9285450a8

Repeat the same calculations using P1, P2, P3, we obtain data strips S1, S2, S3 as:
S₁=6abd9f04dcd33f3d3fe18ed594a85e68 a319f4f9c4ad444e9bbc2d97942ce98c b3b91c4034daff02425777399253975c 5043d7d2e099d43ee95437e526d7c53f
S₂=514931150aa7bb91a4040e7861869611 ab72fe26972cc5f0cc3511e431bd8ec5 c7379ce95363d597781c3b838f7c31ce 41c0d617ad626219d9223104c8e0003f
S₃=03ee734d560d33d38d3a8c9eb71763af e2c7cacfcb59f8f359e4a171dd2e9543 975f77583482c23ab45f03ad17490822 f8efa942f65a2a92d3277b2eb11becd2

Finally we add the strips together: S=S0+S1+S2+S3, again in Galois arithmetic:

S=303132333435363738392b4142434445 464748494a4b4c4d4e4f505152535455 565758595a2b6162636465666768696a 6b6c6d6e6f707172737475767778797a
Which is exactly the correctly recovered original data strip.

### Embodiment Example Four

Refer to same encode settings and data strip of embodiment example one to three. Assume we lost some data. Only 2 data blocks and 2 code blocks survive, as shown below:
Data 2=464748494a4b4c4d 4e4f505152535455
Data 1=565758595a2b6162636465666768696a
Code 1=93ba87aea547cc4d 4ab1f57bb333bd5e
Code 0=7a86c6cb6e627f1a c2253f22daa6a149

The reducer set is: P₀=2¹²⁸+0x80141 and P₁=2¹²⁸+0x80205. The multiplication of all coding parameters, P₀ and P₁, is M=[0 . . . 01] [0 . . . 0344] [0 . . . 0401a228645]. Refer to the method discussed in embodiment example 3, a minimum data strip that produces the code blocks is Sₘ=dd44f14d0e289fed681a2d169c095eef 3867588f3d99b614de2da172ebe03feb.

Alternatively we can calculate code blocks 1 and 0 from a data strip containing just Data 2 and Data 1, and with the missing two data blocks set to zero bytes. Such two code blocks are then subtracted from Code 1 and Code 0, the resulting code blocks are attributed to a data strip containing only the missing Data 3 and Data 0, with Data 2 and Data 1 set to all zero bytes. In this case, Sₘ=ca0441bd32290b3b7067ee86440463bc867087bb774e80ba320c2ebf8b696898.

The correct data strip is obtained by adding above minimum data strip and a certain composites of M, such that the resulting data strip bits agrees with Data 2 and Data 1 blocks. This is done by finding a set of composites Mᵢ=Xᵢ*M, such that each of these composites has just 1 set bit within the positions of Data 2 and Data 1 blocks. Per claim 20 step 20C, We start with M₀=2¹²⁸, M₁=2¹²⁹, M₂=2¹³⁰, . . . M₂₅₅=2³⁸³, add to each one its modulo reduction by M.

And then for each bit position we pick one anchor composite that contains the bit, and cancel that bit from all other composites by subtracting the anchor composite as needed.

Finally with the anchor set, we are able to construct a data strip whose bit pattern agrees with Data 2 and Data 1 block. For each bit that disagrees, we flip the bit by adding the corresponding anchor composite which only contains one anchor bit within the range of Block 2 and 1, thus it only flips the anchor bit when added. The data strip is correctly recovered when all bits within the range of Data 2 and Data 1 blocks are flipped to agree with their expected values.

### Embodiment Example Five

The encoding and decoding described thus far may be implemented by hardware circuits. In one embodiment as shown in FIG. 1, a number of circuits are used to process the input data to produce data blocks and code blocks for later recovery. Binary numeral is assumed.

The embodiment contains one input circuit which feed input bits one bit at a time, most significant bit first and least significant bit last. There is also a counter circuit that counts total number of input bits. When the counter reaches the count of a full data strip, it reset to 0 and also sends a trigger signal to trigger the other circuit parts to output data and code blocks.

There is also a serial chain of shift registers storing the input bits sequentially, with one register storing one data block. When these data registers are triggered by the counter circuit, the data blocks are output for storage and for later recovery.

There is also a plural of shift registers for computing code block, with each shift register operates with feedbacks based on one of the reducers. The input bit is feed into the lowest bit 0. At each operation step, triggered by a cyclic clock cycle, each bit is shifted one position to move to a higher bit, the highest bit becomes the output bit and is feed back to a set of lower bits based on the coding parameter, by an exclusive or (XOR) bit operation. A code block is output for storage and later recovery when the counter circuit sends a trigger signal.

### Embodiment Example Six

Another embodiment example is a data recovery hardware circuit working based on the principles of the current invention. The embodiment contains three circuit parts. One circuit part takes input of recovery code blocks and output a minimum data strip containing a number of data blocks, and is reducible to each code block by each reducer. A second circuit takes input of known data blocks and the minimum data strip from the first circuit, and output a composite data strip that complement the minimum data strip on every bit of the known data block positions. A third circuit combined the known data blocks, the minimum data strip, and the composite data strip to produce the final recovered data strip.

Refer to embodiment example two to four, a large part of the computations for data recovery are independent on the original data blocks, and can be calculated before hand and be reused for subsequent operations. These pre-calculations can be hard-wired in the circuit to directly convert an input to an output, by parallel processing individual input bits, and combine the expected outputs by exclusive or bit operations. Thus, the data recovery circuit can run fast.

### Variations of Embodiments of Current Invention

There can be many variations in embodiments of current invention, using various hardware or software features, and leverage specific instruction sets available. For example, the encoding and decoding steps provided by current invention contains operations of binary Galois arithmetic, including multiplications, which are called carry-less multiplications or polynomial multiplications. Modern computer processors like x86 CPUs and ARM CPUs already include instructions for carry-less multiplication. Such Galois arithmetic instructions, where available, can be used to carry out computations provided by current invention more efficiently.

For example, many x86 CPUs have instruction PCLMULQDQ, which takes a 64 bits register value, do carry-less multiplication by another 64 bits register value, results in 128 bits. ARM V8 and above CPUs have the PMULL and PMULL2 instructions for the same functions.

Application specific integrated circuits (ASICs) can be designed based on principles of the current invention, for better performance and security. For example, specific circuits can be designed to operate on pre-selected reducer parameters that are kept secret. As a result, only specific hardware designed to operate on the same set of reducer parameters can decode the data. An adversary cannot decode the data and thus cannot steal information. For reasonable code block size, like 128 bits, there is an astronomically huge number of usable reducer parameters, like roughly 2¹²⁰ of them, giving 2⁴⁸⁰ possible selections of a four reducer parameter set. This makes it infeasible for an adversary to try to hack the reducer parameters using brute force.

ASICs can also be designed to operate only on set bits of data blocks and reducers, as 0 bits do not affect the computation results and do not need to participate in the operations. Reducers with very few set bits can be selected for use, further reduce required bit operations.

In summary, all such possible variations in the practical embodiments of the current invention, in hardware or software form, do not deviate materially from the basic principles of current invention, and are thus included and incorporated into the claims of current invention.

### Novelty, Non-Obviousness and Usefulness of Current Invention

Claims of current invention are novel, non-obvious and useful compared with all existing error correction and erasure codes. Specifically, current invention takes a fundamentally very different approach from previous dominant algorithms, Reed-Solomon codes, and others.

All error correction and erasure algorithms split a strip of data into multiple data blocks, and then calculate a number of code blocks based on the data blocks, and then transfer or store the blocks separately, hoping that as fewer blocks as possible are produced, yet if some of the blocks are lost, the remaining blocks are sufficient to recover the original data strips fully. To achieve these goals, these three conditions must be meet:
1. Each of the code blocks must depend on all data blocks.
2. Size of all code blocks should be kept small, no bigger than data blocks.
3. Code blocks must be orthogonal to each other, i.e., independent to each other.

Condition 1, each code block must depend on all data blocks, is because logically a code block cannot help to recover a data block it knows nothing about. Thus, a data block must be used in calculation of a code block, for the code block to contain some information of the data block, so as to be able to help recover the data block. Thus computation of any code block must take an entire data strip as input, it cannot be based on partial data inputs.

Condition 2, keep size of code blocks minimal, or at least no bigger than data blocks, is necessary for an erasure code to be useful, since advantage of erasure code is that they use a small data redundancy to help recover data loss. There are two general approaches to keep the code blocks small, while they are calculated from multiple data blocks. First approach is by reduction, through modulo reduction or other means of reduction to reduce a large chunk of code into a small one. Modulo reduction reduces any data size to a block one bit less than the reducer. Second approach is maintain one block size in every step of calculation so the final result is also one block. For example, a subset of data blocks can combined into one block by exclusive or.

Condition 3, the code blocks must be orthogonal or independent from each other, ensures maximal usability of code blocks in data recovery. If a code block can be calculated from a subset of other code blocks, then clearly it does not need to be stored, having the other code blocks is sufficient. Having the dependent code block does not make recoverability better. Ideally, the code blocks complement each other so they have the best chance to recover data.

The Reed-Solomon codes, and a whole variety of other matrix based erasure code achieves condition 1 and 3, by using a parameter matrix to multiply the data block vector to produce code block vector. By carefully designing and selecting the parameters used in the matrix, it ensures that an inverse matrix exists for decoding. Being able to calculate an inverse matrix ensures condition 3, the orthogonal condition, is meet. Each of the code block contains something unique that cannot be derived from the combination of other code blocks. To ensure that code block size is kept in check, Reed Solomon Codes do Galois modulo reduction on all computation results so they all result in one block in size. But that is the only usage of using modulo reduction: to keep code block size limited. Thus the same reduction modulo is use.

The current invention is fundamentally different from Reed-Solomon Codes' use of one modulo to reduce all code blocks and all calculation steps. As seen in Claim 1 step 1C, which anchors the principles of the current invention, separate modulo reducer is used to calculate each code block. A different code block is calculated using a different reducer. No reducer is used for more than one code blocks. Further, current invention does not use a generator polynomial or a matrix to transform the data strip before modulo reduction. It just takes a data strip and calculate modulo reductions using a separate reducer for each code block.

To sum up the differences, Reed-Solomon codes use a generator matrix to produce multiple different values from the same data strip and then do modulo reduction of the different values against the same modulo to obtain multiple code blocks, and rely on a inversion matrix for decoding. But current invention uses no generator and no matrix. It takes the same data strip at the same value, and reduce it by different reducers in order to obtain multiple code blocks, and the same reducer set but very different computation steps are used in the data recovery. This is completely contrary to Reed-Solomon codes using a reverse matrix, thus different parameter set, but using the same computation steps for both encoding and decoding.

The current invention, by using separate reducers for each code block and producing code blocks using straight modulo reduction on the entire data strip, achieves all three conditions of useful erasure codes in one shot. Condition 1, using all data blocks for calculation, is met as the data strip is composed of all data blocks. Condition 2, keep code block size in check, is met by the modulo reduction itself. Condition 3, code blocks must be orthogonal to each other, is met by using different reducer parameters for each code block, and each reducer is irreducible, thus the reducers, as well as reduction they produce, have no dependency on each other.

Such simple usage of multiple reducers is far from being obvious. In nearly 60 years since Reed-Solomon Codes was invented, there has been lots of research and development in the field of error correction and erasure codes, but there has been no know prior art similar to current invention. Instead, researchers focused their efforts on trying to discover more efficient matrix parameters in order to reduce the computation complexity of Reed-Solomon Codes.

There have been other types of erasure code algorithms proposed, for example the EvenOdd Code, RDP codes, X-Codes, Tornado Codes, Data Fountain Codes, Raptor Codes. All of these codes are fundamentally different from both the current invention and Reed-Solomon Code in how these algorithms attempt to meet the second condition of good erasure codes: keep the size of code blocks limited. Instead of using modulo reduction, all these other categories of erasure codes use simple exclusive or bit operation to produce the code blocks from several data blocks, sometimes with the order of the bits permutated first. Since bits permutation and bitwise exclusive or does not produce bigger blocks than input blocks, modulo reduction is not needed.

However all these algorithms, based on the principle exclusive or bit operations, must struggle to meet the third condition of good erasure codes: orthogonal code blocks. There are only very limited few ways found that permutes blocks and bits to produce code blocks that are orthogonal, or independent from each other. Many attempt of new permutation rules end up producing code blocks that depends on each other. Therefore all these XOR-base algorithms, although fast, suffer from very limited code blocks and limited usage in practical application fields. None could replace Reed-Solomon in its flexibility, wide usability and perfect coding efficiency of requiring only K code blocks to decode K data blocks. The only thing that limits Reed-Solomon Code's usage is its complexity.

For this reason, despite of wide availability of many different erasure codes, modern data centers and storage device vendors still choose to use Reed-Solomon Codes to ensure data durability, despite of the complexity problem, there was simply no good alternative until now.

The current invention fundamentally changes that. It has the same flexibility and wide usability and perfect coding efficiency like Reed-Solomon Codes, but does not have the computation complexity issue. Both encoding and decoding provides by current invention scales only at linear complexity, versus quadratic power of Reed-Solomon Codes. Moreover, since the computation steps are highly parallelizable, there is huge potential for hardware embodiments that makes the computation a lot faster, removing complexity as a concern in field applications.

Consider how broadly Reed-Solomon codes were used in various application fields, and how superior current invention is in comparison, the usefulness and valuable nature of the current invention cannot be over-estimated. Specifically, data storage systems have grown to the point where physical failures are routine events. Failures are varied, from disk sectors becoming corrupted, to entire disks or storage sites becoming unusable. Traditional flash memory and the emerging storage devices like 3D XT and optane memory, and even future storage devices based on DNA materials, all suffer from physical reliability issues. A good system must handle those failures quickly and robustly so valuable data is not lost. The current invented coding algorithms can play a vital role to prevent data losses during system failure events. Thus current invention brings huge values to the industry world.

### INDUSTRY APPLICABILITY

The current invention can be used in all application fields of information technology that needs to protect data from damage and loss, including all fields of data communication, networking and data storage, including but not limited to: long distance communication, wired computer networks, wireless Wi-Fi networks, wireless cellular networks, watermarks, 1D and 2D scan codes, information hiding labels, memory chips, storage devices and systems, data centers and data storage devices and systems using novel media materials like DNA storage.

The current inventor claims:

1. A method of processing computer data to produce more than one code blocks that can be used to recover the original computer data, even after some data loss, comprising steps of:
1A. Selecting more than one reducers for data encoding and later data recovery;
1B. Splitting said computer data into data strips, each contain several data blocks.
1C. Selecting an X-nary representation of said data strip and creating each code block by modulo reducing said data strip by each reducer, based on the X-nary system selected;
1D. Retaining created code blocks separately for use later.

2. A method in accordance to claim 1, wherein original computer data is also preserved in addition to code blocks created, comprising of all steps of claim 1 and some extra steps:
2A. Selecting more than one reducers for both data encoding and later recovery;
2B. Splitting said computer data into data strips and further split into data blocks;
2C. Selecting an X-nary representation of said data strip and creating each code block by modulo reducing said data strip by each reducer, based on the X-nary system selected;
2D. Retaining said data and code blocks separately for use later.

3. A method of calculating an X-nary Galois exponential value E^{X} according to claim 1 step 1C, from a base E, exponent X, and a reducer P of S+1 bits, comprising the steps of:
3A. If E has more than S bits, it is reduced by P in accordance to claim 1 step 1C;
3B. If X, considered as a natural number, is 0 or 1, the result is E⁰=1 or E¹=E;
3C. If X is more than 1, split X into n non-zero parts X₁+X₂+ . . . +Xₙ=X, n is at least 2;
3D. Calculate each E^{Xi} respectively using steps 3B, 3C and 3D recursively, then multiply all n exponents together into E^{X}, reducing by P using method 1C of claim 1 at each step.

4. A method to select a said reducer or X-nary in claims 1 and 2, comprising steps of:
4A. Selecting a candidate reducer P, having S+1 bits, S being bit size of data blocks;
4B. Selecting a tester E that is more than 1 and less than P. Record its initial value;
4C. Calculating E^{2̂i} mod P for i from 1 to S, using exponential methods as provided in claim 3. Record if the result equals E at any time before the last round;
4D. After S rounds of step 4C, if final result is not E, reject P and go back to step 4A;
4E. If result also equals E before last round in step 4C, reject the tester E as weak and go to step 4B to pick another tester. Else accept candidate P as a good reducer.

5. A method of detecting data errors in accordance to claim 1 step 1C, comprising steps:
5A. Selecting a suitable reducer P in accordance to the steps of claim 3;
5B. Appending a checksum block to the input data as the least significant block;
5C. Reducing the input data to a code block by P according to claim 1 step 1C;
5D. Adding said code block and a marker block to checksum block in data from step 5B.
5E. Testing if retained data strip is reducible to said marker block, report data error if not.

6. A method of fixing a small data error in accordance to claim 5, comprising steps of:
6A. Reducing said data strip by P and subtracting said marker block based on step 5E of claim 5 to obtain error symptom block E. If E is a zero block, the data strip has no error;
6B. For each block location in said data strip, finding an error block Eᵢ that reduces to E;
6C. Adding the Eᵢ from step 5B with fewest 1 bits to the data strip to fix the data error.
6D. If no Eᵢ has clearly fewer 1 bits than other error blocks, report error as not fixable.

7. A method to find a minimum data strip that reduces to Cᵢ by Pᵢ, and is reducible to 0 by all other K-1 reducers, based on the X-nary representation of a data strip, comprising steps of:
7A. Multiplying all K-1 reducers other than Pᵢ to produce data strip Mᵢ;
7B. Reducing Mᵢ by Pᵢ based on step 1C of claim 1 to obtain Rᵢ;
7C. Calculating Rᵢ⁻¹, or modulo inverse of Rᵢ, using reducer Pᵢ.
7D. Calculating Cᵢ multiplied by Rᵢ⁻¹ then reduced by Pᵢ using step 1C to produce Sᵢ.
7E. Multiplying Mᵢ from step 67A by Sᵢ from step 7D to obtain said minimum data strip.

8. A method to process said code blocks created in accordance to claim 1, using said reducers in accordance to claims 1, and 3, to recover K original data blocks as said in claim 1, in a X-nary representation data strip, using K code blocks and no data blocks, comprising steps of:
8A. Selecting K data blocks and corresponding reducers, if more than K are available;
8B. For each code block Cᵢ, finding a minimum data strip Tᵢ in X-nary which is reduced to Cᵢ by corresponding reducer Pᵢ, but is reducible to 0 by all other selected reducers;
8C. Adding all data strips Tᵢ, from step 8B. The result is recovered original data strip.

9. A method of data recovery according to claim 8, wherein data blocks are retained according to claim 2, as are code blocks created according to claims 1 and 2 in X-nary, using M code blocks and K-M known data blocks, totaling K blocks, comprising steps of:
9A. Constructing a X-nary data strip Tₐ of K blocks, containing all known data blocks, with all missing data blocks replaced with zero bytes;
9B. Reducing Tₐ by each reducer Pᵢ and adding the results to related code blocks Cᵢ;
9C. For each code block Cᵢ in step 9B, finding a minimum data strip Tᵢ that is reduced to Cᵢ by corresponding reducer Pᵢ, but is reducible to 0 by all other selected reducers;
9D. Adding all data strips Tᵢ from step 9C to form a data strip T_{c};
9E. Finding an X-nary composite data strip Tₘ that is reducible by all reducers and also matches data strip T_{c} from step 9D within the known data block locations;
9F. Adding T_{c} from step 9D to Tₘ from step 9E. This recovers missing data blocks.

10. A method of processing computer data in accordance to claim 1, wherein a group of w bits of input data, w being the machine word width, are treated as a single macro bit, and all the bit operation steps of claim 1 apply to the group of bits in parallel, comprising steps of:
10A. Selecting more than one reducers for encoding and for later recovery.
10B. Splitting said computer data into X-nary data strips of blocks of w bits groups;
10C. Creating a code block from a data strip by bit parallel reduction by a reducer;
10D. Retaining the created code blocks separately for use later.

11. A method of processing computer data in accordance to claim 1, wherein the said computer data is also partitioned into data blocks and retained in accordance to claim 2, with bits grouped in w bits each and groups of bits are processed in parallel for all bit operations, all computations using X-nary representation, comprising steps of:
11A. Selecting more than one reducers for encoding and for later recovery.
11B. Splitting said computer data into data strips of blocks of groups of w bits;
11C. Creating a code block from a data strip by bit parallel reduction by a reducer;
11D. Retaining created code and data blocks separately for use later.

12. A method of data recovery in accordance to claim 8, from code blocks produced in accordance to claim 10, with bits grouped by w bits each, and bits in a group are processed in parallel in all data bits operation steps in accordance to claims 7 and 8, comprising steps of:
12A. Selecting K code blocks and corresponding reducers, if more than K are available;
12B. For each code block Cᵢ, of bit groups, finding a minimum data strip Tᵢ which is reduced to Cᵢ by related reducer Pᵢ, but is reducible to 0 by all other selected reducers;
12C. Adding all data strips Tᵢ, from step 12B to obtain a recovered data strip in X-nary.

13. A method of data recovery in accordance to claim 9, from both data blocks and code blocks produced in accordance to claim 11, with blocks contain groups of w bits, and bits in a group are processed in parallel in all bit operation steps in claims 7 and 9, comprising steps of:
13A. Constructing a data strip Tₐ of K blocks, containing all known data blocks, with all missing data blocks replaced with zero blocks, each block contains groups of w bits;
13B. Reducing Tₐ by each reducer and subtracting the result from the related code block;
13C. For each code block Cᵢ in step 13B, finding a minimum data strip Tᵢ, reducible to Cᵢ by related reducer Pᵢ, but reducible to 0 by all other selected reducers;
13D. Adding together all the data strips Tᵢ from step 13C to form a data strip T_{c};
13E. Finding an X-nary composite data strip Tₘ reducible by all reducers and also matches data strip T_{c} from step 13D within the known data block locations;
13F. Adding T_{c} from step 13D to Tₘ from step 13E to recovers all missing data blocks.

14. A method of processing input data in accordance to claim 2, wherein said input data comes from multiple sources, with each source contributing a data block to form a data strip to be processed to create code blocks in accordance to the steps of claim 2, comprising steps of:
14A. Selecting more than one reducers for both data encoding and later recovery;
14B. Constructing a data strip by obtaining each data block from separate sources;
14C. Creating each code block by modulo reducing said data strip by each reducer;
14D. Retaining created code blocks separately and separate from source of step 14B.

15. A method of data recovery in accordance to claim 9, from code blocks produced in accordance to claim 14, wherein after processing by steps in accordance to claim 9 to recover a data strip, said recovered data strip contains original data blocks from multiple sources, and is further split into recovered data blocks to return to their original sources, comprising steps of:
15A. Constructing an X-nary data strip Tₐ of K blocks, with all known data blocks obtained from separate sources, and all missing data blocks replaced with zero bytes;
15B. Reducing Tₐ by each reducer and subtracting the result from the related code block;
15C. For each code block Cᵢ in step 15B, finding a minimum X-nary data strip Tᵢ that is reduced to Cᵢ by related reducer Pᵢ, but is reducible to 0 by all other reducers;
15D. Adding together all the data strips Tᵢ from step 15C to form a data strip T_{c};
15E. Finding a composite data strip Tₘ, reducible by all reducers and also matches data strip T_{c} from step 15D within all known block locations;
15F. Adding T_{c} from step 15D to Tₘ from step 15E. Result contains missing data blocks;
15G. Splitting data strip in step 15F into data blocks to return to their sources, as needed.

16. A method of improving data durability by recursive data encoding and recovery in accordance to steps in claim 2 and claim 9, comprising steps of:
16A. Processing input data to created data and code blocks based on steps in claim 2.
16B. Treating data and code blocks from step 16A as secondary input data and further process them based on steps in claim 2, and retaining secondary code and data blocks;
16C. Recovering secondary input data, which is also output of step 16A, from secondary code and data blocks from step 16B in accordance to steps provided in claim 9;
16D. Further process output of step 16C in accordance to steps provided in claim 9 to recover the original input data which was the input data provided in Step 16A.

17. A method of secured data storage and recovery wherein the code blocks produced in accordance to claim 1 are distributed to multiple parties for storage, with each party retaining insufficient number of blocks or reducers used, and thus is unable to recover data, thus original data content is protected from exposure to third parties, comprising steps of:
17A. Selecting more than one reducers for both data encoding and later recovery;
17B. Creating a code block by reducing data by a reducer based on step 1C of claim 1.
17C. Distributing some code blocks and some reducers to multiple parties for retention, but withhold certain other code blocks and reducers from said parties, so that all parties, even conspired as a group, still have insufficient information to recover the original data, thus original data content is protected from exposure;
17D. Retrieving distributed code blocks from third parties, with some data loss possible.
17E. Recovering original data from available code blocks and privately withheld code blocks and reducers, using data recovery steps in accordance to claim 8.

18. A method of data protection in accordance to claims 1 and 17, wherein code blocks are distributed to multiple parties in such ways to ensure only authorized parties will have sufficient information to recover original data in accordance to steps in claim 8, and other parties do not have sufficient information for data recovery, comprising steps of:
18A. Selecting more than one reducers for both data encoding and later recovery;
18B. Creating each code block by modulo reducing said original data by each reducer;
18C. Distributing some code blocks and some reducers to third parties for retention, but withhold certain other code blocks and reducers from said third parties, such that all the third party members, even conspired together as a group, still has insufficient information to recover the original data, thus original data content is protected from exposure;
18D. Distributing additional code blocks and reducers to authorized parties so that said parties have sufficient information to recover data based on steps provided in claim 8.
18E. Authorized parties can recover data using data recovery steps provided in claim 8.

19. A method of protected data distribution in accordance to claims 1, 17 and 18, wherein code blocks and reducers are distributed to multiple parties in such ways to ensure no individual party has sufficient information to recover data, but a sufficient group of parties may co-operate so as to recover data in accordance to steps provided in claim 8, comprising steps of:
19A. Selecting more than one reducers for both data encoding and later recovery;
19B. Creating each code block by modulo reducing said original data by each reducer;
19C. Distributing some code blocks and some reducers to multiple parties for retention, but withhold certain other code blocks and reducers from each said parties, in such ways that no party individually have sufficient information to recover data, but a sufficiently large group may co-operate to obtain enough information for recovery based on claim 8;
19D. When a sufficient group of parties decide to co-operate, the group obtains enough information and proceed to recover data based on steps provided in claim 8.

20. A method to find a set of composite data strips in an X-nary numeral system that are reducible by all M reducers, and a composite data strip in said set contains only one set bit out of target bits within (K-M) specific block locations, each block having S bits, such set of composite data strips are used in claims 9, 13 and 15 that requires composite data strips, comprising steps of:
20A. Finding M suitable reducers according to steps of claim 4 and steps in claim 1.
20B. Multiplying all M reducers together to produce a composite data strip Sₘ in X-nary.
20C. Creating a set of N=(K-M)*S data strips Sᵢ=2^{ms+i}−(2^{ms+i} mod Sₘ), i=0 to N-1;
20D. For each Sᵢ, setting a target bit bᵢ by finding a Sⱼ, j>i and bᵢ is set, and add Sⱼ to Sᵢ. Then for each j≠i, clear the target bit bᵢ from Sⱼ if the bit is set, by adding Sᵢ to Sⱼ;
20E. If step 20D fails to find a suitable Sⱼ, go to step 20A to find another set of reducers.
20F. Storing set of Sᵢ, each reducible by all reducers and has one set bit within target bits.
